(19) United States
(12) Patent Application Publication
(10) Pub. No.: US 2005/0071422 A1
(43) Pub. Date: Mar. 31, 2005

(54) Method, system, and computer program product for an automation tool adapter for use with multiple different automation tools

(75) Inventors: Bruce R. Booth, Richmond Hill (CA); Rhonda L. Childress, Austin, TX (US); Stewart Jason Hyman, Toronto (CA); Karry Allan Keown, Calgary (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/671,215

(22) Filed: Sep. 25, 2003

(51) Int. Cl. G06F 15/16

(52) U.S. Cl. 709/203

(57) ABSTRACT

A system, method, and computer program product are disclosed for providing a single automation tool adapter for use with multiple different automation tools. Multiple different clients are monitored for automation requests. An automation request that is to be executed within one of the automation tools is received from one of the clients in an original format. A second format that is required by the automation tool is determined. The automation request is converted from the original format to the second format. The automation request is then submitted in the second format to the automation tool for processing. Automation requests are submitted to an automation tool in a format that is required by the automation tool.

### BACKGROUND OF THE INVENTION

1. Technical Field

The present invention relates generally to the field of computer systems, and more specifically to a method, system, and computer program product for providing a single automation tool adapter for use with multiple different automation tools.

2. Description of Related Art

Many proprietary systems or devices accept programmatic input for making changes to the device. An automation tool is any application that interfaces with a system or device to enact a sequence of automated changes, via one of these programmatic interfaces. When such applications are not provided by the vendor, it is common practice to create scripts that call Command Line Interface (CLI) commands in a particular sequence to perform tasks (i.e. Create a VLAN in a Cisco Switch, Initiate a Copy Task on an IBM Storage device, etc.). There are no standards that govern these programmatic interfaces or automated tools.

Many different automation tools may exist within a single environment. Each automation tool may have its own unique format that it requires for requests. Thus, a request sent to a first automation tool might be required to be in a first format while a request sent to a second automation tool might be required to be in a second, different, format.

In order to use the many different automation tools, each object could be required to put its requests in the proper format required by the requested automation tool. This approach is not practical, however, in systems having even a few potential requesting objects and a few different automation tools, or in a system where rapid addition of new automation tools is required.

One approach to automate the use of the many different automation tools is to provide a different, custom process for each automation tool. Thus, each automation tool would have an associated custom process. Each custom process would then receive requests from the various objects requesting the associated automation tool, convert the received request into the format required by its associated automation tool, and then forward the request to the tool.

This automation approach is not efficient for systems having many different automation tools. In such a system, many different custom processes would be required. These custom processes would require a large development effort, as well as strong knowledge of the entire automation framework. An even larger management and maintenance effort is also required to continue to support all of these custom processes as the environment is updated.

In addition, this automation approach would suffer from possible conflicts when two or more automation tools need to act on the same set of end devices. Thus, additional complex code is needed to serialize the use of the tools to avoid these possible conflicts.

Therefore, a need exists for a method, system, and computer program product for providing a single automation tool adapter that can be used with multiple different automation tools.

### SUMMARY OF THE INVENTION

A system, method, and computer program product are disclosed for providing a single automation tool adapter for use with multiple different automation tools. Multiple different automation clients are monitored by the present invention for automation requests. An automation request for one of the automation tools is received from one of the clients in an original format. A second format that is required by the automation tool is determined. The automation request is converted from the original format to the second format. The automation request is then submitted in the second format to the automation tool for processing. A reply message from the automation tool is transformed into the format of the original request before being returned to the automation client. In this manner, automation requests are submitted to an automation tool in the format that is required by the automation tool.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system that may be utilized to implement the present invention in accordance with the present invention;

FIG. 2 is a block diagram which illustrates a logical design and process flow of an automation tool adapter in accordance with the present invention;

FIG. 3 illustrates a high level flow chart which depicts a queue listener process in accordance with the present invention;

FIG. 4 depicts a high level flow chart which illustrates a verb dispatcher process in accordance with the present invention;

FIG. 5 illustrates a high level flow chart which depicts an automation processor in accordance with the present invention; and

FIG. 6 depicts a high level flow chart which illustrates a reply server process in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

Automation requests are received in messages in the present invention in the form of data payloads delivered via an asynchronous messaging system. The data payload of an automation request may be in one of several formats, such as an XML document or a set of name/value pair parameters. Information contained in the automation request is to be forwarded to an automation tool indicated by the request for processing.

The particular automation tool and associated tool configuration parameters are determined by the workflow verb as found in the automation request. There is a configuration file where the automation tool is specified for each type of automation request that is received. Therefore, the automation client does not have to maintain working knowledge of the specific tool that is used for each type of automation request. This allows the automation client to focus on the logical automation operation is it trying to carry out, rather then the unrelated information about how to actually carry it out. The format of the information comprising an automation request is not necessarily the same format as that used and required by the automation tool.

Automation request information may be transferred between multiple request formats, such as XML, name/value, and JavaBeans, as determined by the automation tool requirements. Additionally, automation request parameter names may be mapped to specific parameter names that are required by a particular automation tool.

In order to facilitate the transformation of automation request information between formats, the present invention supports the mapping, also called translation, of individual data elements between request formats and automation tool formats. For example, an automation request may be received as an XML document and transformed into a flat file containing a set of name/value pairs before being presented to an automation tool for processing. Results received from an automation tool may similarly be transformed from a format supported by the automation tool to a format required by the requester.

The present invention handles automation request information based on the format of the request, mapping specifications, and the format requirement of the automation tool. The following process is applied to each automation request:
(1) The contents of the automation request are extracted from the asynchronous message and the format of the automation request parameters is determined.
(2) The format requirement of the destination automation tool is determined from the contents of the automation request.
(3) The automation request parameters are extracted from the automation request. If a mapping for a specific parameter name is found in the automation tool's configuration file, it is mapped to that new parameter name. If a mapping is not found, a default transformation is applied.
(4) The resulting mapped automation request parameters are transformed into the format required by the automation tool and passed to the automation tool.
(5) Results received from an automation tool are mapped back to the format used by the requester of the original automation request in a similar manner.

For example, if an automation request is received in an XML formation containing tags such as:
<city>
   <machine>
      <IPAddress>10.11.12.13</IPAddress>
   </machine>
</city>
   and the automation tool configuration file contains a mapping such as:
<map name=“city_machine_IPAddress”>
   <parameterTag>host.address</parameterTag>
</map>
   and the automation tool required a name/value format, then a parameter file would be produced for the automation tool containing the following line:
host.address=10.11.12.13

If the automation tool instead required parameters in an XML format, then an XML document would be produced containing the following tags:
<host>
   <address>10.11.12.13</address>
   </host>

By providing automation request format and parameter naming transformation, the present invention effectively insulates both the automation requester and the automation tool from changes in each other. It is critical that this functionality be in place in order to ensure long-term support for automation tools with varying requirements and capabilities.

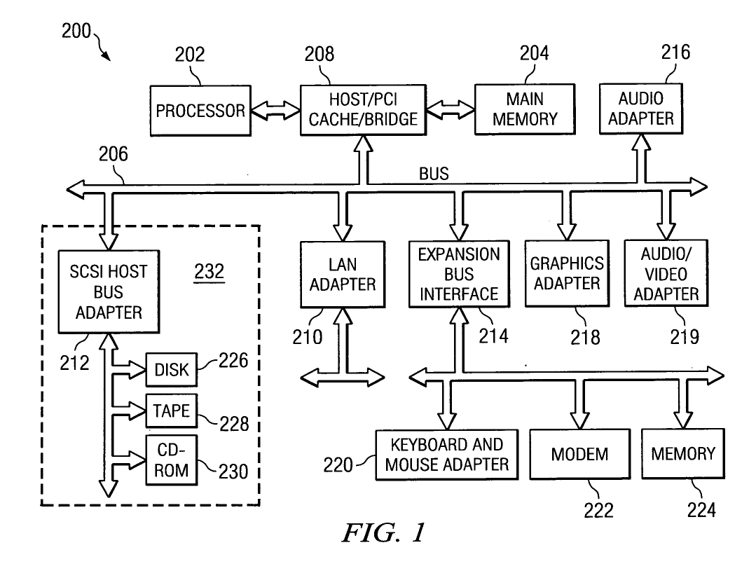

FIG. 1 is a block diagram illustrating a data processing system that may be utilized to implement a server, client, object request broker, or any other computer system in accordance with the present invention. Data processing system 200 employs a peripheral component interconnect (PCI) local internal bus architecture. Although the depicted example employs an internal PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards.

In the depicted example, network card 210, SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. Small computer system interface (SCSI) host bus adapter 212 provides a connection for hard disk drive 226, tape drive 228, and CD-ROM drive 230. Typical PCI local bus implementations will support three or four PCI expansion slots or add-in connectors.

Those of ordinary skill in the art will appreciate that the hardware in FIG. 1 may vary depending on the implementation. Other internal hardware or peripheral devices, such as flash ROM (or equivalent nonvolatile memory) or optical disk drives and the like, may be used in addition to or in place of the hardware depicted in FIG. 1.

As another example, data processing system 200 may be a stand-alone system configured to be bootable without relying on some type of network communication interface, whether or not data processing system 200 comprises some type of network communication interface. As a further example, data processing system 200 may be a Personal Digital Assistant (PDA) device, which is configured with ROM and/or flash ROM in order to provide non-volatile memory for storing operating system files and/or user-generated data.

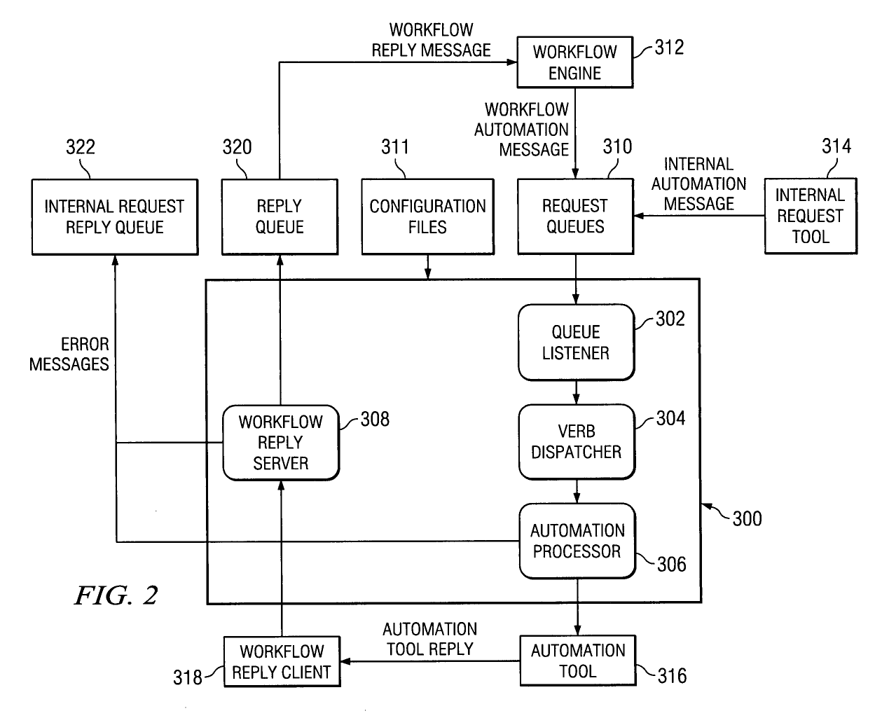

FIG. 2 is a block diagram which illustrates a logical design and process flow of an automation tool adapter 300 in accordance with the present invention. Automation tool adapter 300 includes a queue listener 302, a verb dispatcher 304, an automation processor 306, and a workflow reply server 308. Multiple different request queues 310 receive messages that include requests from a workflow engine 312 or an internal request tool 314. Block 310 represents one or more queues. Each request queue 310 is associated with a distinct queue listener 302.

Configuration files 311 are processed at startup time. These files 311 are then available for use by queue listener 302, verb dispatcher 304, automation processor 306, and workflow reply server 308 as described herein. The configuration file has stanzas for each known action verb that specifies which automation tool should be used when a request that includes that verb is received. In addition, the configuration file includes a specification of an expected format for each automation tool. This format is the format required by the particular automation tool for its received requests and is the format used by the tool for its replies. Thus, a request must be in this format before the request is sent to the tool. The tool will then process the request and provide a reply to the request in that same format.

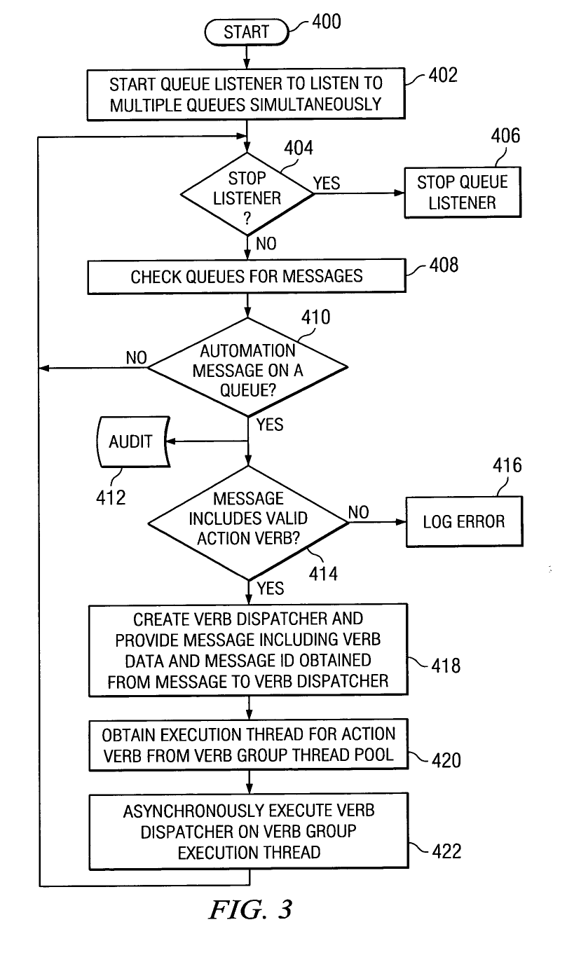

Each queue listener 302 waits on an associated request queue 310 for a message to arrive. If a queue receives a message that includes a request that needs to be processed by an automation tool, a queue listener 302 passes the request to verb dispatcher 304. A more detailed description of the queue listener process is described below with reference to FIG. 3.

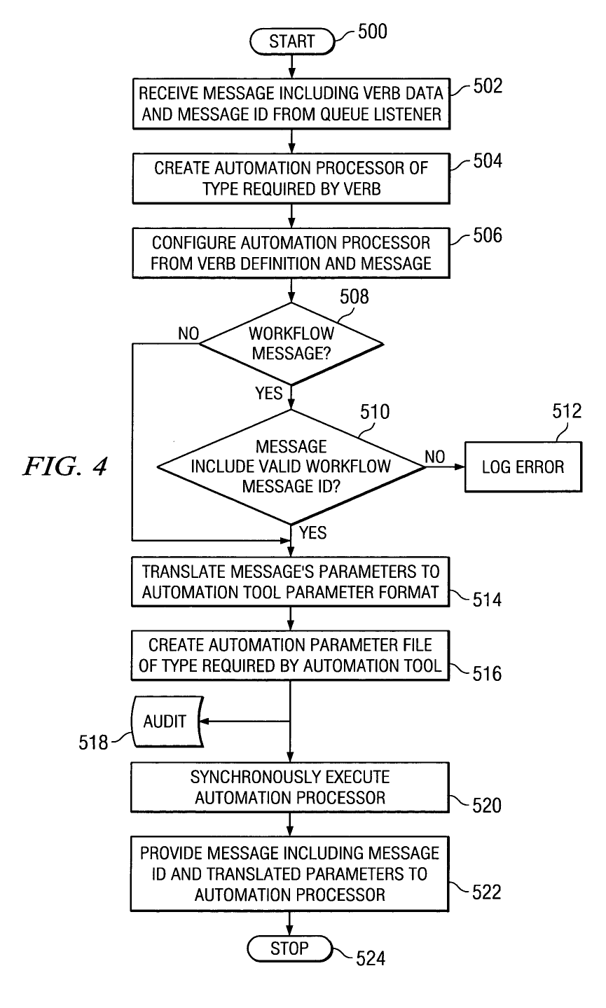

Verb dispatcher 304 examines the request, determines the verb name that describes the request, creates an automation processor of the type required by the verb, and translates the parameters of the request to the format required by the automation tool. Verb dispatcher 304 then passes the translated parameters to the automation processor 306. A more detailed description of the verb dispatcher process is described below with reference to FIG. 4.

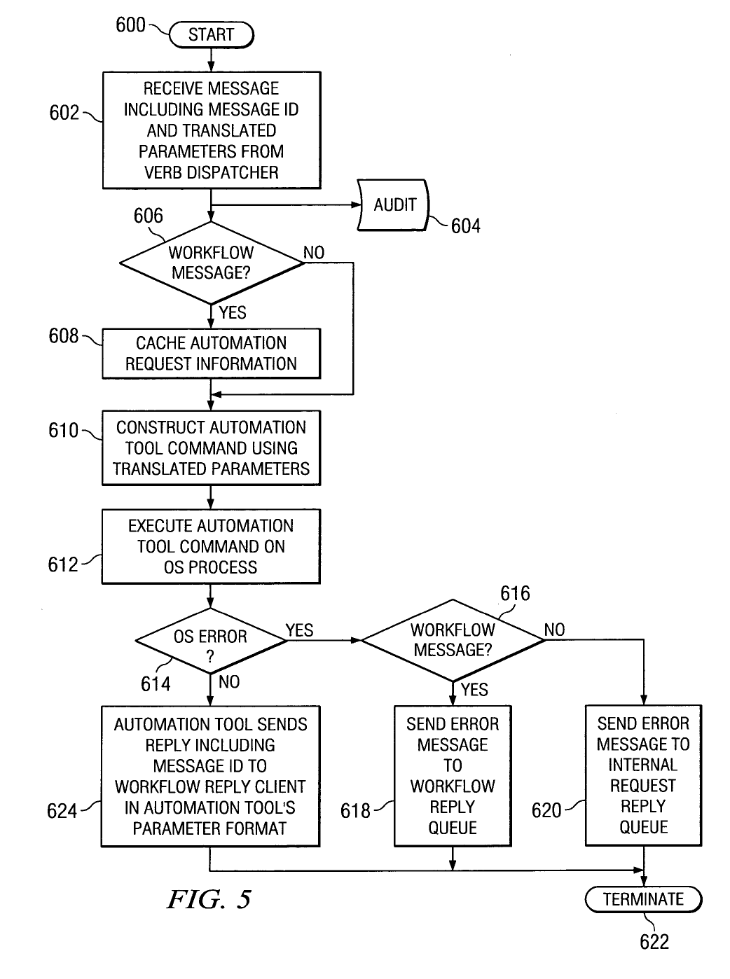

Automation processor 306 constructs an automation tool command using the translated parameters, and executes the automation tool command using automation tool 316. Automation processor 306 provides any error messages to internal request reply queue 322. A more detailed description of the automation processor process is described below with reference to FIG. 5.

Automation tool 316 executes the command that it received from automation processor 306. The parameters from the original request have been translated to a format required by automation tool 316. After executing the command, automation tool 316 provides the results of the execution of the command to the workflow reply client 318 when then provides the results to the workflow reply server 308.

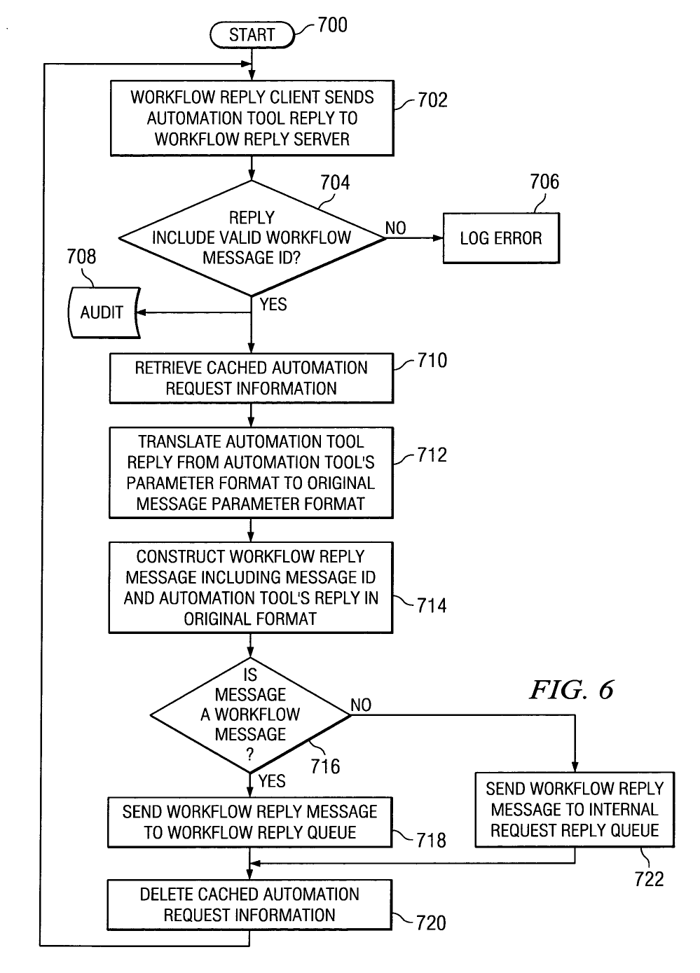

Workflow reply server 308 receives the results of the execution and translates the results into a format required by the original requester. Workflow reply server 308 provides any error messages to internal request reply queue 322. A more detailed description of the workflow reply server process is described below with reference to FIG. 6.

Workflow reply server 308 puts a workflow reply message to Reply queue 320, containing the results of the execution of the original request in the format of the original request. The workflow reply message is then read from the Reply queue 320 to provide the results to the workflow engine 312.

A message identifier is included throughout the process described above in order to uniquely identify the particular request and to identify its requester. This message identifier is passed along with the request as described in more detail below.

FIG. 3 illustrates a high level flow chart which depicts a queue listener process in accordance with the present invention. The process starts as depicted by block 400 and thereafter passes to block 402 which illustrates starting a queue listener for each queue to be monitored. Next, block 404 depicts a determination of whether or not the listener is to be stopped. If a determination is made that the listener is to be stopped, the process passes to block 406 which illustrates stopping the queue listener. Referring again to block 404, if a determination is made that the queue listener is not to be stopped, the process passes to block 408 which depicts the queue listener checking a queue for messages. One or more queues may be provided in one or more computer systems, each with its own queue listener. The queue listener will check its queue for messages.

The process then passes to block 410 which illustrates a determination of whether or not an automation message is present in the queue. If a determination is made that no automation message is present in the queues, the process passes back to block 404. An automation message is a message that includes a request to be executed using one of the automation tools.

Referring again to block 410, if a determination is made that an automation message is present in the queue, the process passes to block 412 which depicts auditing the process which includes recording the time stamped, original contents of the automation request message and an associated unique transaction identifier. If a determination is made that an automation message is present in one of the queues, the process also passes to block 414 which illustrates a determination of whether or not the message includes a valid action verb defined in the automation tool configuration file(s). As described above, the configuration files map Automation Request verbs to automation tools. All of the verbs mapped to automation tools are considered “valid action verbs”, but if a verb is received that has no map defined to an automation tool, then there is no way of knowing how to process that verb, and it is considered invalid. If a determination is made that the message does not include a valid action verb, the process passes to block 416 which depicts logging an error.

The workflow request received on the queue specifies one of the object managers. The request is received in XML format and contains a unique verb name and request ID. The request may also contain additional data for input to the automation tool that is responsible for responding to the request. Data for input to the automation tool must be passed to that tool in one of the accepted formats. The workflow manager will expect a reply to the request.

The unique verb ID is passed to the automation tool, and then returned in the tool's reply to this request to the workflow manager. Data for output to the workflow manager must be passed to the reply tool in the same format that was used to pass the request to the automation tool.

Verbs may be dispatched in parallel.

Referring again to block 414, if a determination is made that the message does include a valid action verb, the process passes to block 418 which illustrates creating a verb dispatcher and providing the message to the verb dispatcher. Each message includes a message identifier (ID) that identifies the particular message as well as the object that originally made the request. The object that made the request is also referred to herein as a requester. Block 418 illustrates passing the message including the verb data and message ID to the verb dispatcher.

Thereafter, block 420 depicts obtaining an execution thread for the action verb from the verb group thread pool. Each automation verb available to the present invention is defined as belonging to a single specific verb group. A verb group may contain multiple automation verbs, but an automation verb may belong to only one verb group. The function of a verb group is to limit the maximum number of concurrent execution threads available to the set of all automation verbs defined as belonging to a verb group. This thread control strategy serves to protect from excessive load, and to control the number of concurrent automation processes running against a specific automation tool.

When the present invention is started, automation verb and verb group definitions are obtained from an XML configuration file. Each verb definition specifies the verb group to which that verb belongs. Each verb group definition specifies the name of the verb group and the maximum number of concurrent threads available to that thread group. Each verb group is assigned a threadpool configured with a maximum number of concurrent threads, a minimum number of available threads, and the maximum time that a thread may be idle before it is considered stale.

All threadpools are registered by verb group name with a threadpool manager object. The threadpool manager is responsible for providing a public interface into the threadpools registered to it, and provides a single point of control for all threadpools. The threadpool manager starts and stops all threadpools and returns a threadpool reference by verb group name. The threadpool manager is also capable of obtaining threadpool statistics from an active threadpool. Available threadpool statistics include configuration information, number of requests in progress, number of available threads and idle threads, and the number of pending requests.

When an automation request is received, it is parsed and the automation verb is obtained. The threadpool assigned to the verb group to which the automation verb belongs is obtained from the threadpool manager. A verb dispatcher object is created to control the automation request processing and is forwarded to the threadpool for execution. If an idle thread is available from the threadpool, the verb dispatcher is executed immediately. If a thread is not available (all threads are in use) the threadpool will attempt to create a new thread constrained by the maximum number of concurrent threads, and execute the verb dispatcher on that new thread. If a new thread cannot be created (the maximum number of concurrent threads has been reached), the automation request is queued up by the threadpool to be executed on the next available thread. Threads exceeding a designated maximum idle time are considered stale and are discarded.

Each instance of the queue listener is configured to listen for automation requests on a single asynchronous message queue. Each message queue listener executes on a separate thread but uses the same threadpool manager to control the execution of verb dispatchers. In this manner, the execution of automation requests received from different sources is controlled through a common threading mechanism.

The process then passes to block 422 which depicts asynchronously executing the verb dispatcher on the verb group execution thread. The process then passes back to block 404.

FIG. 4 depicts a high level flow chart which illustrates a verb dispatcher process in accordance with the present invention. The process starts as depicted by block 500 and thereafter passes to block 502 which illustrates receiving a request message including verb data and a message ID from the queue listener. Thereafter, block 504 depicts creating an automation processor of the type required by the received verb. An automation processor encapsulates the operating system-specific command mechanism by which an automation verb is to be invoked. Next, block 506 illustrates configuring the automation processor from the verb definition and message.

The process then passes to block 508 which depicts a determination of whether or not this is a workflow message. If a determination is made that this is not a workflow message, the process then passes to block 514. Referring again to block 508, if a determination is made that this is a workflow message, the process passes to block 510 which illustrates a determination of whether or not this message includes a workflow message ID. If a determination is made that this message does not include a workflow message ID, the process passes to block 512 which illustrates logging an error.

Referring again to block 510, if a determination is made that this message does include a valid workflow message ID, the process passes to block 514 which depicts translating the message's parameters from their original format into the format required by the requested automation tool. Thereafter, block 516 illustrates creating an automation parameter file of a type that is required by the requested automation tool. The process then passes to block 518 which depicts auditing the process. The process also passes to block 520 which illustrates synchronously executing the automation processor. Next, block 522 depicts providing the message, including the message ID and the translated parameters, to the automation processor. The process then terminates as depicted by block 524.

FIG. 5 illustrates a high level flow chart which depicts an automation processor in accordance with the present invention. The process starts as depicted by block 600 and thereafter passes to block 602 which illustrates receiving a message including the message ID and translated parameters from a verb dispatcher. The process then passes to block 604 which depicts auditing the process. The process also passes to block 606 which illustrates a determination of whether or not this is a workflow message. If a determination is made that this is not a workflow message, the process passes to block 610. If a determination is made that this a workflow message, the process passes to block 608 which depicts caching the automation request information. Cached automation request information includes request type, request transaction identifiers, and reply queue destination. The process then passes to block 610.

Block 610, then, illustrates constructing an automation tool command using the translated parameters. Next, block 612 depicts executing the automation tool command on an operating system (OS) process. Thereafter, block 614 illustrates a determination of whether or not there is an OS error. If a determination is made that there is an OS error, the process passes to block 616 which depicts a determination of whether or not this is a workflow message. If a determination is made that this is a workflow message, the process passes to block 618 which illustrates sending an error message to the workflow reply queue. The process then terminates as depicted by block 622. Referring again to block 616, if a determination is made that this is not a workflow message, the process passes to block 620 which illustrates sending an error message to the internal request reply queue. The process then terminates as depicted by block 622.

Referring again to block 614, if a determination is made that no OS error occurred, the process passes to block 624 which depicts the automation tool sending a reply including the message ID to the workflow reply client in the automation tool's parameter format. The process then passes to block 622.

FIG. 6 depicts a high level flow chart which illustrates a workflow reply server process in accordance with the present invention. The process starts as depicted by block 700 and thereafter passes to block 702 which illustrates the workflow reply client sending the automation tool reply to the workflow reply server. Next, block 704 depicts a determination of whether or not the reply includes a valid workflow message ID. If a determination is made that the reply does not include a valid workflow message ID, the process passes to block 706 which illustrates logging an error.

Referring again to block 704, if a determination is made that the reply does include a valid workflow message ID, the process passes to block 708 which illustrates auditing the process. The process also passes to block 710 which depicts retrieving the cached automation request information. Next, block 712 illustrates translating the automation tool's reply from the parameter format used by the automation tool that the reply is in to the format used by the requester that the original request was in.

Thereafter, block 714 depicts constructing a workflow reply message including the message ID and the automation tool's reply in the original format. The process then passes to block 716 which illustrates a determination of whether or not the message is a workflow message. If a determination is made that the message is a workflow message, the process passes to block 718 which depicts sending the workflow reply message to the workflow reply queue. Thereafter, block 720 illustrates deleting the cached automation request information. The process then passes back to block 702. Referring again to block 716, if a determination is made that the message is not a workflow message, the process passes to block 722 which depicts sending the workflow reply message to the internal request reply queue. The process then passes to block 720.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for providing a single automation tool adapter for use with multiple different automation tools, said method comprising the steps of:
monitoring a plurality of clients for automation requests;
receiving, from one of said plurality of clients, an automation request in an original format to be executed within one of said automation tools;
determining a second format required by said one of said automation tools;
converting said automation request from said original format to said second format; and
submitting said automation request in said second format to said one of said automation tools for processing, wherein automation requests are submitted to one of said automation tools in a format required by said one of said automation tools.

2. The method according to claim 1, wherein said steps of monitoring a plurality of clients for automation requests and receiving, from one of said plurality of clients, an automation request further includes the steps of:
providing a plurality of request queues; and
checking each one of said plurality of request queues for a message.

3. The method according to claim 2, further comprising the steps of:
each one of said plurality of request queues being located in a different one of said plurality of clients.

4. The method according to claim 1, further comprising the steps of:
determining said second format required by said one of said automation tools utilizing a configuration file that includes a specification of a format for each one of said plurality of automation tools.

5. The method according to claim 1, further comprising the steps of:
receiving said automation request in said original format which is an XML document format; and
converting said automation request from said XML document format to a flat file containing a set of name/value pairs, wherein said flat file format is said second format.

6. The method according to claim 1, further comprising the steps of:
including a unique identifier in each one of a plurality of received requests;
said automation request being included in said plurality of received requests; and
including a first identifier in said automation request.

7. The method according to claim 1, further comprising the steps of:
including a unique identifier in each one of a plurality of received automation requests; and
tracking each one of said plurality of received automation requests utilizing said unique identifier.

8. The method according to claim 1, further comprising the steps of:
processing said automation request by said one of said automation tools;
generating, by said one of said automation tools, a reply to said automation request in response to a completion of processing of said automation request by said one of said automation tools;
said reply being in said second format;
converting said reply to said original format; and
transmitting said converted reply in said original format to said one of said plurality of clients.

9. The method according to claim 8, further comprising the steps of:
including a unique identifier in each one of a plurality of received requests;
said automation request being included in said plurality of received requests;
including a first identifier in said automation request;
including said first identifier in said converted reply.

10. A data processing system for providing a single automation tool adapter for use with multiple different automation tools, comprising:
a plurality of clients generating automation requests;
an automation request received from one of said plurality of clients in an original format to be executed within one of said automation tools;
a second format required by said one of said automation tools;
said automation request being converted from said original format to said second format; and
said automation request being submitted in said second format to said one of said automation tools for processing, wherein automation requests are submitted to one of said automation tools in a format required by said one of said automation tools.

11. The system according to claim 10, further comprising:
a plurality of request queues; and
a queue listener for checking each one of said plurality of request queues for a message.

12. The system according to claim 11, further comprising:
each one of said plurality of request queues being located in a different one of said plurality of clients.

13. The system according to claim 10, further comprising:
a configuration file that includes a specification of a format for each one of said plurality of automation tools for determining said second format required by said one of said automation tools.

14. The system according to claim 10, further comprising:
said original format being an XML document format; and
said second format being a flat file containing a set of name/value pairs.

15. The system according to claim 10, further comprising:
a unique identifier included in each one of a plurality of received requests;
said automation request being included in said plurality of received requests; and
said automation request including a first identifier.

16. The system according to claim 10, further comprising:
a unique identifier included in each one of a plurality of received automation requests; and
said unique identifier for tracking each one of said plurality of received automation requests.

17. The system according to claim 10, further comprising:
said one of said automation tools for processing said automation request;
said one of said automation tools generating a reply to said automation request in response to a completion of processing of said automation request by said one of said automation tools;
said reply being in said second format;
said reply being converted to said original format; and
said converted reply being transmitted in said original format to said one of said plurality of clients.

18. The system according to claim 17, further comprising:
a unique identifier included in each one of a plurality of received requests;
said automation request being included in said plurality of received requests;
said automation request including a first identifier;
said converted reply including said first identifier.

19. A computer program product in a data processing system for providing a single automation tool adapter for use with multiple different automation tools, said product comprising:
instruction means for monitoring a plurality of clients for automation requests;
instruction means for receiving, from one of said plurality of clients, an automation request in an original format to be executed within one of said automation tools;
instruction means for determining a second format required by said one of said automation tools;
instruction means for converting said automation request from said original format to said second format; and
instruction means for submitting said automation request in said second format to said one of said automation tools for processing, wherein automation requests are submitted to one of said automation tools in a format required by said one of said automation tools.

20. The product according to claim 19, wherein said instruction means for monitoring a plurality of clients for automation requests and receiving, from one of said plurality of clients, an automation request further includes:
instruction means for providing a plurality of request queues; and
instruction means for checking each one of said plurality of request queues for a message.

21. The product according to claim 20, further comprising:
each one of said plurality of request queues being located in a different one of said plurality of clients.

22. The product according to claim 19, further comprising:
instruction means for determining said second format required by said one of said automation tools utilizing a configuration file that includes a specification of a format for each one of said plurality of automation tools.

23. The product according to claim 19, further comprising:
instruction means for receiving said automation request in said original format which is an XML document format; and
instruction means for converting said automation request from said XML document format to a flat file containing a set of name/value pairs, wherein said flat file format is said second format.

24. The product according to claim 19, further comprising:
instruction means for including a unique identifier in each one of a plurality of received requests;
said automation request being included in said plurality of received requests; and
instruction means for including a first identifier in said automation request.

25. The product according to claim 19, further comprising:
instruction means for including a unique identifier in each one of a plurality of received automation requests; and
instruction means for tracking each one of said plurality of received automation requests utilizing said unique identifier.

26. The product according to claim 19, further comprising:
instruction means for processing said automation request by said one of said automation tools;
instruction means for generating, by said one of said automation tools, a reply to said automation request in response to a completion of processing of said automation request by said one of said automation tools;
said reply being in said second format;
instruction means for converting said reply to said original format; and
instruction means for transmitting said converted reply in said original format to said one of said plurality of clients.

27. The product according to claim 26, further comprising:
instruction means for including a unique identifier in each one of a plurality of received requests;
said automation request being included in said plurality of received requests;
instruction means for including a first identifier in said automation request;
instruction means for including said first identifier in said converted reply.
